(19) United States
(12) Patent Application Publication
(10) Pub. No.: US 2015/0271023 A1
(43) Pub. Date: Sep. 24, 2015

(54) CLOUD ESTIMATOR TOOL

(71) Applicants: Neal David ANDERSON, Laurel, MD (US); William T. SNYDER, Laurel, MD (US); Elinna SHEK, Aldie, VA (US); James Richard MACDONALD, Catharpin, VA (US)

(72) Inventors: Neal David ANDERSON, Laurel, MD (US); William T. SNYDER, Laurel, MD (US); Elinna SHEK, Aldie, VA (US); James Richard MACDONALD, Catharpin, VA (US)

(73) Assignee: NORTHROP GRUMMAN SYSTEMS CORPORATION, Falls Church, VA (US)

(21) Appl. No.: 14/221,027

(22) Filed: Mar. 20, 2014

(51) Int. Cl. H04L 12/24

(52) U.S. Cl. CPC H04L 41/0866

(57) ABSTRACT

A cloud estimator tool can be configured to analyze a server configuration profile that characterizes hardware parameters for a node of a potential cloud computing environment and a load profile that characterizes computing load parameters for the potential cloud computing environment to generate a cloud computing configuration for the potential cloud computing environment. The cloud estimator tool determines a performance estimate and a cost estimate for the cloud computing configuration based on the hardware parameters and the computing load parameters characterized in the server configuration profile and the load profile.

### TECHNICAL FIELD

This disclosure relates to a cloud computing environment, and more particularly to a tool to estimate configuration, cost, and performance of a cloud computing environment.

### BACKGROUND

Cloud computing is a term used to describe a variety of computing concepts that involve a large number of computers connected through a real-time communication network such as the Internet, for example. In many applications, cloud computing operates as an infrastructure for distributed computing over a network, and provides the ability to run a program or application on many connected computers at the same time. This also more commonly refers to network-based services, which appear to be provided by real server hardware, and are in fact served up by virtual hardware, simulated by software running on one or more real machines. Such virtual servers do not physically exist and can therefore be moved around and scaled up (or down) on the fly without affecting the end user.

Cloud computing relies on sharing of resources to achieve coherence and economies of scale, similar to a utility (like the electricity grid) over a network. At the foundation of cloud computing is the broader concept of converged infrastructure and shared services. The cloud also focuses on maximizing the effectiveness of the shared resources. Cloud resources are usually not only shared by multiple users but are also dynamically reallocated per demand. This can work for allocating resources to users. For example, a cloud computer facility that serves European users during European business hours with a specific application (e.g., email) may reallocate the same resources to serve North American users during North America's business hours with a different application (e.g., a web server). This approach can maximize the use of computing power thus reducing the environmental impact as well since less power, air conditioning, rack space, and so forth is required for a variety of computing functions. As can be appreciated, cloud computing systems can be vast in terms of hardware utilized and the number of operations that may need to be performed on the hardware during periods of peak demand. To date, no comprehensive model exists for predicting the scale, cost, and performance of such systems.

### SUMMARY

This disclosure relates to a tool to estimate configuration, cost, and performance of a cloud computing environment. The tool can be executed via a non-transitory computer readable medium having machine executable instructions, for example. In one aspect, a cloud estimator tool can be configured to analyze a server configuration profile that characterizes hardware parameters for a node of a potential cloud computing environment and a load profile that characterizes computing load parameters for the potential cloud computing environment to generate a cloud computing configuration for the potential cloud computing environment. The cloud estimator tool determines a performance estimate and a cost estimate for the cloud computing configuration based on the hardware parameters and the computing load parameters characterized in the server configuration profile and the load profile.

In another aspect, an estimator model can be configured to monitor a parameter of a cloud configuration and determine a quantitative relationship between a server configuration profile and a load profile based on the monitored parameter. A cloud estimator tool employs the estimator model to analyze a server configuration profile that characterizes hardware parameters for a node of a potential cloud computing environment and a load profile that characterizes computing load parameters for the potential computing environment to generate a cloud computing configuration for the potential cloud computing environment. The estimator model can be further configured to determine a performance estimate and a cost estimate for the cloud computing configuration based on the hardware parameters of the configuration profile and the computing load parameters of the load profile.

In yet another aspect, a graphical user interface (GUI) for a cloud estimator tool includes a configuration access element to facilitate configuration of a server configuration profile that characterizes hardware parameters for a node of a potential cloud computing environment. The interface includes a workload access element to facilitate configuration of a server-inbound or ingestion workload for the potential cloud computing environment. The interface includes a queryload access element to facilitate configuration of a query workload in addition to the inbound workload for the potential cloud computing environment. A cloud estimator actuator can be configured to actuate the cloud estimator tool in response to user input. The cloud estimator tool can be configured to generate a load profile that includes computing load parameters for the potential cloud computing environment based on the server-inbound workload and the query workload. The cloud estimator tool can generate a cloud computing configuration and a corresponding price estimate for the potential cloud computing environment based on the server configuration profile and the load profile. The interface can also include a calculated results access element configured to provide information characterizing the cloud computing configuration and the corresponding performance estimate.

### BRIEF DESCRIPTION OF THE DRAWINGS

FIG. 1 illustrates an example of a tool to estimate configuration, cost, and performance of a cloud computing environment.

FIG. 2 illustrates an example model generator for determining an estimator model that can be employed by a cloud estimator tool to estimate configuration, cost, and performance of a cloud computing environment.

FIG. 3 illustrates an example interface to specify a server configuration profile for a cloud estimator tool.

FIG. 4 illustrates an example estimator results output for a cloud estimator tool.

FIG. 5 illustrates an example interface to specify an inbound or ingestion workload profile for a cloud estimator tool.

FIG. 6 illustrates an example interface to specify a queryload/response profile for a cloud estimator tool.

FIG. 7 illustrates an example interface to specify a network and rack profile for a cloud estimator tool.

FIG. 8 illustrates an example network and rack configuration that can be generated by a cloud estimator tool.

FIG. 9 illustrates an example interface to specify an assumptions profile for a cloud estimator tool.

### DETAILED DESCRIPTION

This disclosure relates to a tool and method to estimate configuration, cost, and performance of a cloud computing environment. The tool includes an interface to specify a plurality of cloud computing parameters. The parameters can be individually specified and/or provided as part of a profile describing a portion of an overall cloud computing environment. For example, a server configuration profile describes hardware parameters for a node in a potential cloud computing environment. A load profile describes computing load requirements for the potential cloud computing environment. The load profile can describe various aspects of a cloud computing system such as a data ingestion workload and/or query workload that specify the type of cloud processing needs such as query and ingest rates for the cloud along with the data complexity requirements when accessing the cloud.

A cloud estimator tool generates an estimator output file that includes a cloud computing configuration having a scaled number of computing nodes to support the cloud based on the load profile parameters. The cloud estimator tool can employ an estimator model that can be based upon empirical monitoring of cloud-based systems and/or based upon predictive models for one or more tasks to be performed by a given cloud configuration. The estimator model can also generate cost and performance estimates for the generated cloud computing configuration. Other parameters can also be processed including network and cooling requirements for the cloud that can also influence estimates of cost and performance. Users can iterate (e.g., alter parameters) with the cloud estimator tool to achieve a desired balance between cost and performance. For example, if the initial cost estimate for the cloud configuration is prohibitive, the user can alter one or more performance parameters to achieve a desired cloud computing solution.

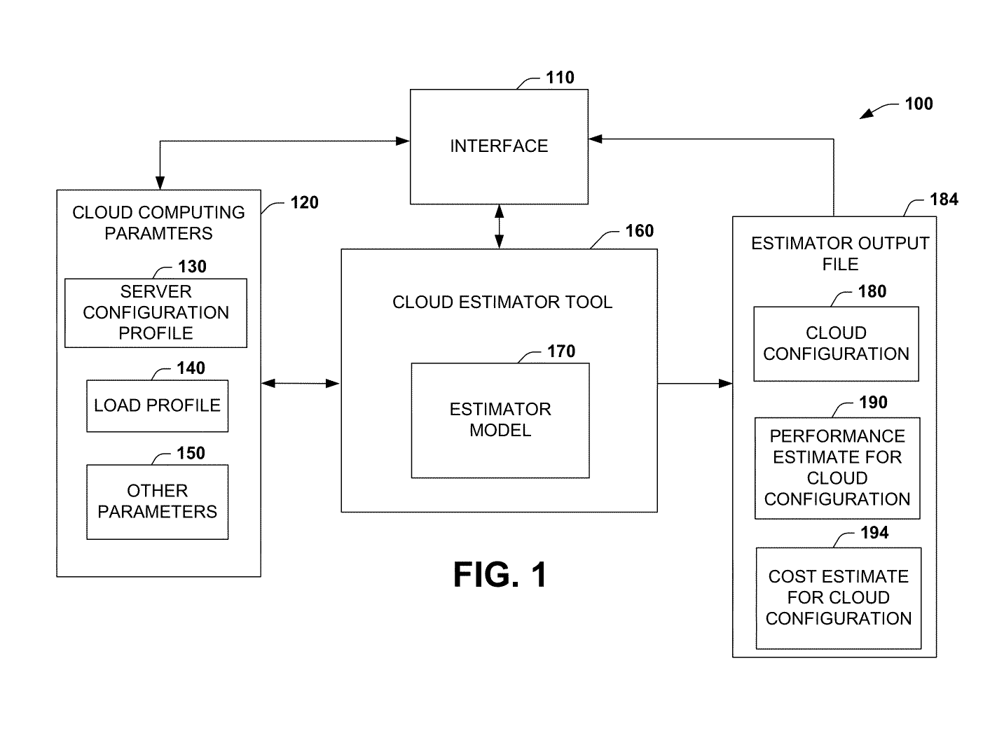

FIG. 1 illustrates an example of a tool 100 to estimate configuration, cost, and performance of a cloud computing environment. As used herein, the term cloud refers to at least two computing nodes (also referred to as a cluster) operated by a cloud manager that are connected by a network to form a computing cloud (or cluster). Each of the nodes includes memory and processing capabilities to collectively and/or individually perform tasks such as data storage and processing in general, and in particular, render cloud services such as e-mail services, data mining services, web services, business services, and so forth. The cloud manager can be substantially any software framework that operates the cloud and can be an open source framework such as Hadoop or Cloud Foundry, for example. The cloud manager can also be a proprietary framework that is offered by a plurality of different software vendors.

The tool 100 includes an interface 110 (e.g., graphical user interface) to receive and configure a plurality of cloud computing parameters 120. The cloud computing parameters 120 can include a server configuration profile 130 that describes hardware parameters for a node of a potential cloud computing environment. Typically, a single node is specified of a given type which is then scaled to a number of nodes to support a given cloud configuration. The server configuration file 120 can also specify an existing number of nodes. This can also include specifying some of the nodes as one type (e.g., Manufacturer A) and some of the nodes as another type (Manufacturer B), for example. The interface 110 can also receive and configure a load profile 140 that describes computing load parameters for the potential cloud computing environment. The load profile 140 describes the various types of processing tasks that may need to be performed by a potential cloud configuration. This includes descriptions for data complexity which can range from simple text data processing to more complex representations of data (e.g., encoded or compressed data). As will be described below, other parameters 150 can also be processed as cloud computing parameters 120 in addition to the parameters specified in the server configuration profile 130 and load profile 140.

A cloud estimator tool 160 employs an estimator model 170 to analyze the cloud computing parameters 120 (e.g., server configuration profile and load profile) received and configured from the interface 110 to generate a cloud computing configuration 180 for the potential cloud computing environment. The cloud computing configuration 180 can be generated as part of an estimator output file 184 that can be stored and/or displayed by the interface 110. The estimator model 170 can also determine a performance estimate 190 and a cost estimate 194 for the cloud computing configuration 180 based on the cloud computing parameters 120 (e.g., hardware parameters and the computing load parameters received from the server configuration profile and the load profile).

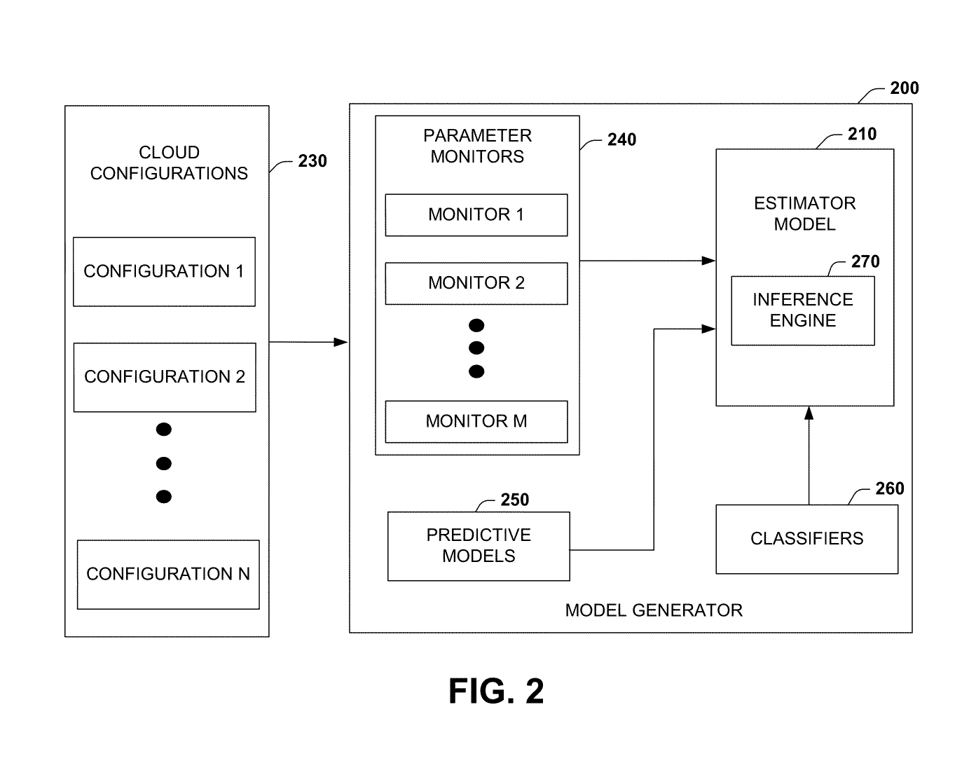

The cloud computing configuration 180 generated by the cloud estimator tool 160 can include a scaled number of computing nodes and network connections to support a generated cloud configuration and based on the node specified in the server configuration profile 130. For example, the server configuration profile 130 can specify a server type (e.g., vendor model), the number of days needed for storage (e.g., 360), server operating hours, initial disk size, and CPU processing capabilities, among other parameters, described below. Depending on the parameters specified in the load profile 140, the cloud estimator tool 160 determines the cloud configuration 180 (e.g., number of nodes, racks, and network switches) based on estimated cloud performance requirements as determined by the estimator model 170. As will be described below with respect to FIG. 2, the estimator model 170 can be based upon empirical monitoring of actual cloud operating parameters (e.g., monitoring Hadoop parameters from differing cloud configurations) and/or from monitoring modeled cloud parameters such as from cloud simulation tools. Predictive models can also be constructed that provide estimates of an overall service (e.g., computing time needed to serve a number of web pages) or estimate individual tasks (e.g., times estimated for the individual operations of a program or task) that collectively define a given service.

The load profile 140 can specify various aspects of computing and data storage/access requirements for a cloud. For example, the load profile 140 can be segmented into a workload profile and/or a query load profile which are illustrated and described below. Example parameters specified in the workload profile include cloud workload type parameters such as simple data importing, filtering, text importing, data grouping, indexing, and so forth. This can include descriptions of data complexity operations which affect cloud workload such as decoding/decompressing, statistical importing, clustering/classification, machine learning and feature extraction, for example. The query load profile can specify query load type parameters such as simple index query, MapReduce query, searching, grouping, statistical query, among other parameters that are described below. In addition to the load profile 140, other parameters 150 can also be specified that influence cost and performance of the cloud configuration 180. This can include specifying network and rack parameters in a network profile and power considerations in an assumptions profile which are illustrated and described below.

The cloud estimator tool 160 enables realistic calculations of the performance and size of a cloud configuration (e.g., Hadoop cluster architectures) against a set of user's needs and selected performance metrics. The user can supply a series of data points about the work in question via the interface 110, and the estimator output file 184 (e.g., output of “Calculated Results”) lists the final calculations. For many cloud manager models, two of the driving factors are the data storage size needed for any project and the estimated MapReduce CPU loading to ingest/query the cloud or cluster. The estimator model 170 estimates these two conditions, concurrently, since they are generally not independent in nature. The cost and size modeling can be a weighted aggregate summation of the processing time, CPU memory, I/O, CPU nodes, and data storage, for example. In one example, the estimator model 170 can employ average costs of hardware equipment, installation, engineering, and operating costs to generate cost estimates. The results in the estimator output file 184 can reflect values based on industry and site averages.

As used herein, the term MapReduce refers to a framework for processing parallelizable problems across huge datasets using a large number of computers (nodes), collectively referred to as a cluster (if all nodes are on the same local network and use similar hardware) or a grid (if the nodes are shared across geographically and administratively distributed systems, and use more heterogeneous hardware). Computational processing can occur on data stored either in a file system (unstructured) or in a database (structured). MapReduce typically involves a Map operation and a Reduce operation to take advantage of locality of data, processing data on or near the storage assets to decrease transmission of data. The Map operation is when a master cluster node takes the input, divides it into smaller sub-problems, and distributes them to worker nodes. A worker node may perform this again in turn, leading to a multi-level tree structure. The worker node processes the smaller problem, and passes the answer back to its master node. The Reduce operation is where the master cluster node then collects the answers to all the sub-problems and combines them in some manner to form the output thus, yielding the answer to the problem it was originally trying to solve.

FIG. 2 illustrates an example model generator 200 for determining an estimator model 210 that can be employed by a cloud estimator tool to estimate configuration, cost, and performance of a cloud computing environment. Various cloud configurations 230, shown as configuration 1 through N, with N being a positive integer are monitored and analyzed by the model generator 200. Each configuration 230 represents a different arrangement of node clusters that support a given cloud configuration. Each configuration can also include differing load profiles which represent differing workload requirements for the given configuration. In one aspect, a plurality of parameter monitors 240, shown as monitors 1 though M, are employed by the model generator 200 to monitor performance of a given configuration 230 and in view of the number of nodes and computing power of the given configuration. Thus, the estimator model 210 can monitor one or more parameters of one or more cloud configurations via the parameter monitors 240 to determine a relationship between a server configuration profile and a load profile, for example.

Based on such monitoring, the estimator model 210 can be developed such that various mathematical and/or statistical relationships are stored that describe a relationship between a given hardware configuration versus a given load profile for the respective hardware configuration. In some cases, actual system configurations 230 and workloads can be monitored. In other cases, the configurations 230 can be operated and described via a simulator tool, for example, which can also be monitored by the parameter monitors 240. Example parameter monitors include CPU operations per seconds, number of MapReduce cycles per second, amount of data storage required for a given cloud application, data importing and exporting, filtering operations, data grouping and indexing operations, data mining operations, machine learning, query operations, encoding/decoding operations, and so forth. Other parametric monitoring can include monitoring hardware parameters such as the amount power consumed for a given cloud configuration 230, for example. After parametric processing, the estimator model 210 can then predict cost and performance of a server/load profile combination based on an estimated server node configuration for the cloud and the number of computing resources estimated for the cloud.

In addition to the parameter monitors 240, the estimator model 210 can be developed via predictive models 250. Such models can include estimates based on a plurality of differing factors. In some cases, programs that may operate on a given configuration 230 can be segmented into workflows (e.g., block diagrams) that describe the various tasks involved in the respective program. Processing time and data storage estimates can then be assigned to each task in the workflow to develop the predictive model 250. Less granular predictive models 250 can also be employed. For example, a given web server program may provide a model estimate for performance based on the number users, number of web pages served per second, number of complex operations per second, and so forth. In some cases, the predictive model 250 may provide an average estimate for the load requirements of a given task or program.

In yet another example, the estimator model 210 can be developed via classifiers 260 that are trained to analyze the configurations 230. The classifiers 260 can be support vector machines, for example, that provide statistical predictions for various operations of the configurations 230. For example, such predictions can include determining maximum and minimum loading requirements, data storage estimates in view of the type of application being executed (e.g., web server, data mining, search engine), relationships between the numbers of nodes in the cloud cluster to performance, and so forth.

Information flow from the cloud configurations 230, the parameter monitors 240, the predictive models 250 and the classifiers 260 can be supplied to an inference engine 270 in the estimator model 210 to concurrently reduce the supplied system loading and usage requirements, along with the selected user settings, to arrive at a composite result set. A system operating profile can be deduced from the received cloud configurations 230, and this can be applied to the parameters supplied by parameter monitors 240, to establish a framework for the calculation. This framework can then set the limits and scope of the calculations to be performed on the model 210. It then applies the predictive model from 250, and the classifiers from 260 against this framework. The inference engine 270 then utilizes a set of calculations to concurrently solve, from this mixed set of interdependent parameters a best fit of the conditions.

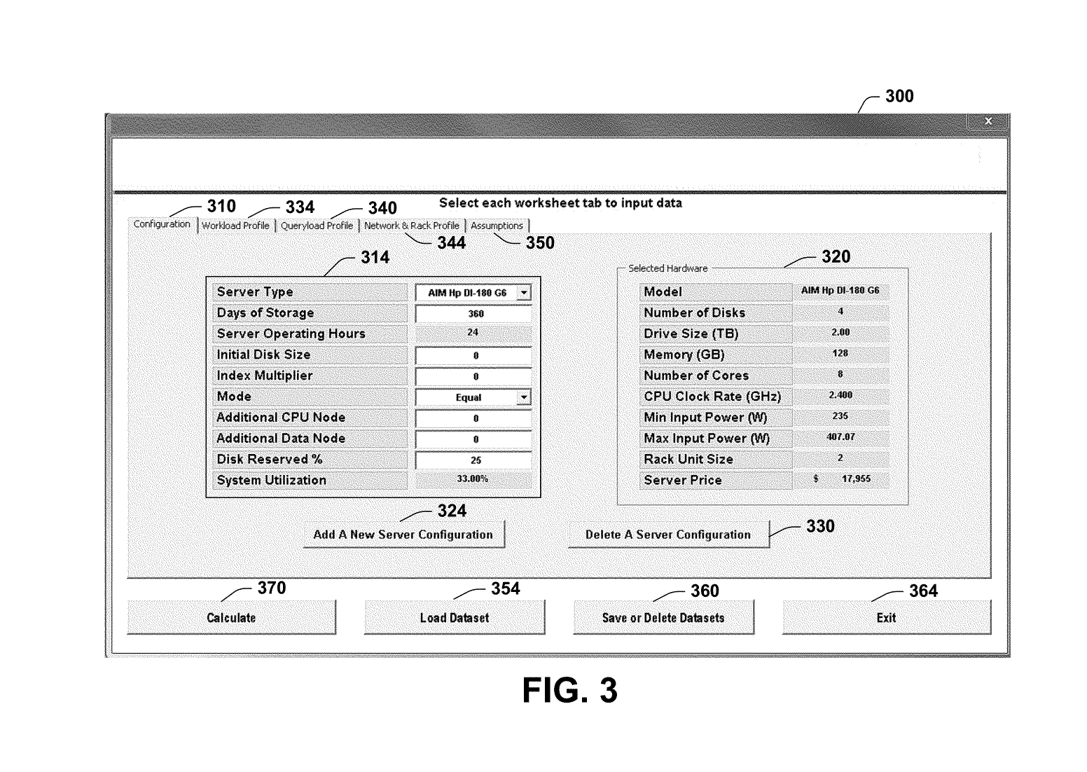

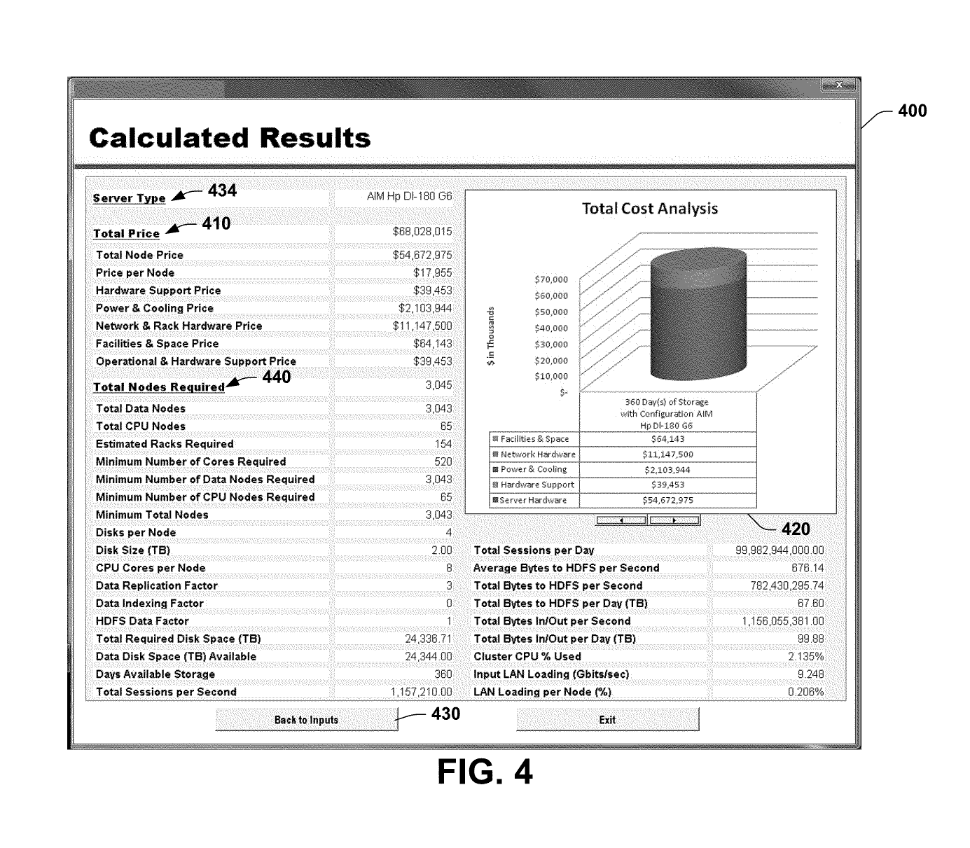

The inference engine 270 estimates from the supplied settings and user details (e.g., from interface 300 of FIG. 3), such interactive segments as, the profile of configured system usages, and derives from this the amount of free resources to be applied for the calculations. These resources can include such items as free CPU, free disk space, free LAN bandwidth, and other measures of pertinent system sizing and performance, for example. These calculated free resources can then be used to derive the capability of the system to perform the actions and workload requested by the user. A best fit of the resources can be performed to arrive at the specific details of the predictive model as the calculated results (e.g., see example results output of FIG. 4).

FIG. 3 illustrates an example interface 300 to specify a server configuration profile for a cloud estimator tool. When a configuration tab 310 is selected, a Server Type Selector box 314 appears. There is a predetermined number of server configurations that can be selected (e.g., 15), consisting of e.g., an AIM's configuration and optional user-specified configurations. An AIM's server hardware configuration can serve as the base configuration for calculating a cluster (e.g., Hadoop cluster). In one example, all nodes of the cluster are of the same configuration however, it is possible to specify different combinations of nodes for a cluster. The hardware configuration is displayed in an adjacent “Selected Hardware” frame 320 when a server type is selected. To customize a configuration, the user can click “Add a New Server Configuration” button 324 on the configuration tab 310.

New server configurations can be saved in the “Saved_Data” worksheet for future calculations. To delete user-added server configuration the user can select a “Delete A Server Configuration” button 330. As will be illustrated and described below, other tabs that can be selected include a workload profile tab 334, a queryload profile tab 340, a network and rack profile tab 344, and an assumptions tab 350. Data sets describing a given cloud configuration can be loaded via a load data set tab 354 and saved/deleted via tab 360. An exit tab 364 can be employed to exit and close the cloud estimator tool.

The server type selector box 314 can also include a Days of Storage Input Field that is the average number of days the system stays in operation, where a default value is 1. A Server Operating Hours Label in the box 314 automatically calculates the server operating hours by multiplying the days of storage by 24 hours in a day. An Initial Disk Size Input Field in box 314 can be entered in bytes (e.g., 100 GB). An Index Multiplier Input Field in box 314 can be used to estimate the number of indexes a job may need to create. This multiplier adjusts the workload and the HDFS storage size. A Mode Selector in box 314 allows the user to select the partition mode type by data (Equal) or CPU (Partition). An additional CPU Node Input Field in box 314 enables an entry of existing number of CPU Nodes. An additional Data Node Input Field in box 314 enables an entry of an existing number of Data Nodes.

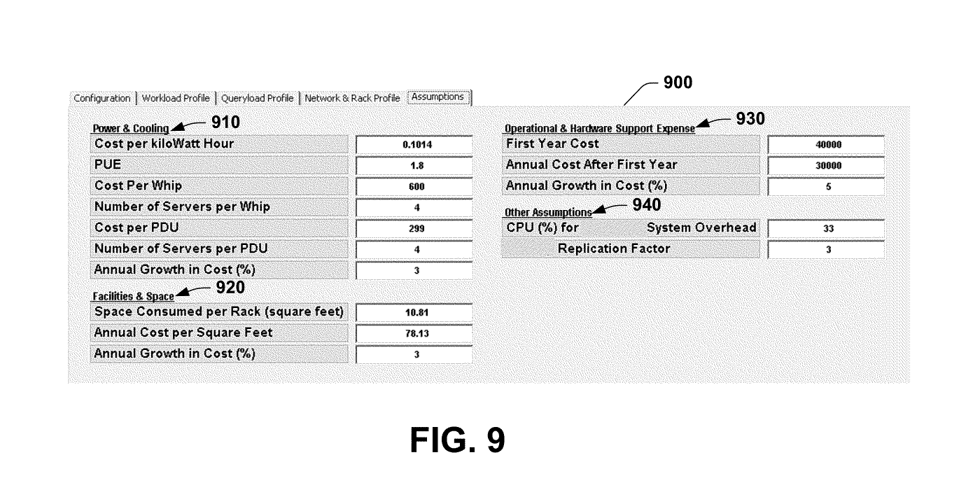

A Disk Reserved % Input Field in box 314 allows users to save a percentage of the disk that is reserved for other purposes. A System Utilization Label in box 314 specifies system utilization and on default can be 33% when servers are idle. The 33% is the CPU percentage reserved for cluster (e.g., Hadoop) and system overheads. Users can change the percentage reserved with the CPU (%) for System Overhead field on the Assumptions worksheet tab illustrated and described below with respect to FIG. 9. After the other profiles have been configured via tabs 334, 340, 344, and 350, a calculate button 370 can be selected which commands the cloud estimator tool to generate an output of a cloud configuration including performance and cost estimates for the respective configuration based on the selected parameters for the respective profiles. The calculated or estimated output is illustrated and described below with respect to FIG. 4.

FIG. 4 illustrates an example estimator results output 400 for a cloud estimator tool. The estimator results output also referred to as Calculated Results form 400 will display when the “Calculate” button 370 described above with respect to FIG. 3 on the input form is clicked. The form 400 provides a total price 410 and its pricing factors, the system's statistics and specifications of the selected server type. The result form 400 also displays a Total Cost Analysis chart 420, including a Yearly Cost & Total Cost of Ownership, a Node Composition chart, and a 1st Year Cost by Configuration Type comparison chart. To make adjustments or changes to the results 400, the user can click on a “Back to Inputs” button 430 to go back to the input form & profile selector described above with respect to FIG. 3.

When a Server Type has been selected as shown at 434, Total Price for the system can be displayed at 410. This can include a Total Node Price, Price per Node, Hardware Support Price, Power & Cooling Price, Network Hardware Price, Facilities & Space Price, and Operational & Hardware Support Price. A Total Nodes Required output at 440 can include a Total Data Nodes, Total CPU Nodes, Estimated Racks Required, Minimum Number of Cores Required, Minimum Number of Data Nodes Required, Minimum Number of CPU Nodes Required, and Minimum Total Nodes. This can include Disks per Node Disk Size (TB), CPU Cores per Node, Data Replication Factor, Data Indexing Factor, HDFS Data Factor, Total Required Disk Space (TB), Data Disk Space (TB) Available, and Days Available Storage. Performance output on the form 400 can include Total Sessions per Second, Total Sessions per Day, Average Bytes to HDFS per Second, Total Bytes to HDFS per Second, Total Bytes to HDFS per Day (TB), Total Bytes In/Out per Second, Total Bytes In/Out per Day (TB), Cluster CPU % Used, Input LAN Loading (Gbits/sec), and LAN Loading per Node (%), for example.

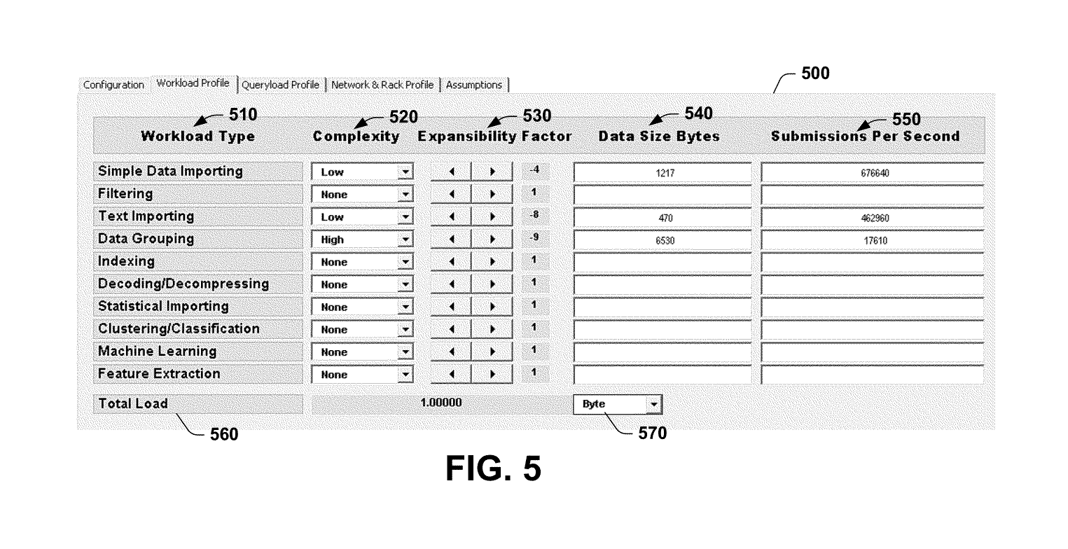

FIG. 5 illustrates an example interface 500 to specify a workload profile for a cloud estimator tool. Under a “Workload Type” at 510, a series of general workload categories define server-bound workloads that can include input/output (I/O)-bound workloads (e.g., data access submissions/requests to hard disk) and CPU-bound workloads (e.g., CPU cache processing requests), for example. The workload types can include simple data importing, filtering, text importing, data grouping, indexing, decoding/decompressing, statistical importing, clustering/classification, machine learning, and feature extraction, for example. At 520, a Workload Complexity Selector enables each of the base workload types to be augmented with the Complexity selector. Users can choose the complexity as none, low, medium and high to tune the weight of the job type.

At 530, an Expansibility Factor is set as a default expansibility factor to 1, which indicates that all of the data bytes are processed by the MapReduce framework. A negative expansibility factor indicates that a reduction (−) is taken on the total data bytes processed. A “−4” expansibility factor, for example, implies that the total data bytes processed by MapReduce is reduced by 40%. A positive expansibility factor greater than 1 indicates that the total data bytes processed by the MapReduce have increased by the expansion (+) factor. A Data Size Bytes Input Fields at 540 indicates data size per submission of the selected workload type and is entered in bytes. At 550, Submissions per Second Input Fields indicate the number of Submissions per Second, or input work rate (e.g., Files), are the number of requests made by user(s) that are of the selected workload type. At 560, a Total Load Label indicates a workload's total input bytes per second and is the calculation of its submissions per second multiplied by its data size bytes. The total load is the summation of all the workload's total input bytes per second. This total load figure is the initial total bytes of stored data. Thus, expansibility factor is not included in the calculation. Users can also display the total load in “Byte, Kilobyte, Megabyte, or Gigabyte” units by selecting the unit of measurement from the byte conversion selector on the right of the total load label at 570.

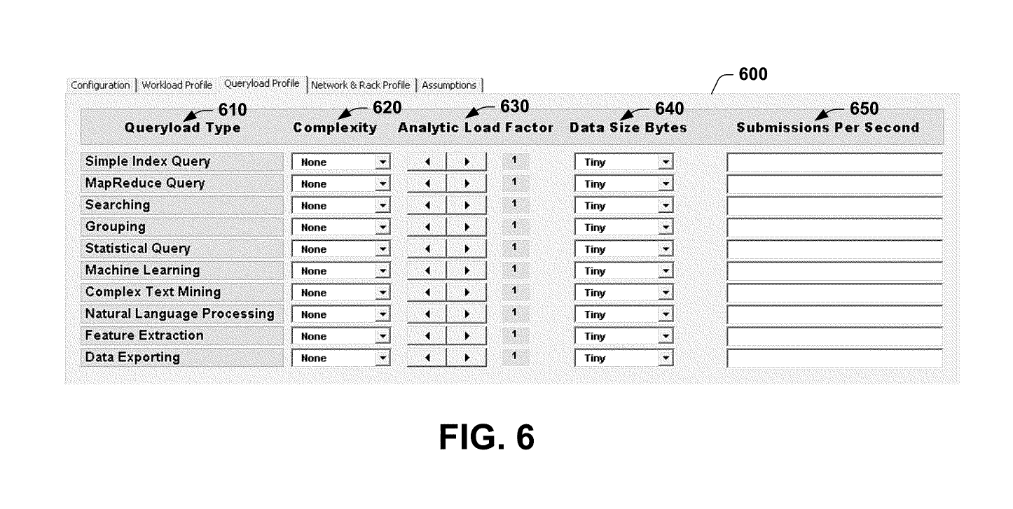

FIG. 6 illustrates an example interface 600 to specify a queryload profile for a cloud estimator tool. The queryload profile 600 specifies an amount and rate at which queries are submitted to and responses received from a cluster (e.g., number of MapReduce operations required for a given cluster service). At 610, a Queryload Type can include categories such as simple index queries, MapReduce queries, searching, grouping, statistical query, machine learning, complex text mining, natural language processing, feature extraction, and data importing, for example. At 620, a complexity factor for the query category can be specified which describes loading requirements to process a given query (e.g., light load for simple query/query response, heavy load for data mining query/query response). At 630, an Analytic Load Factor can be specified with a default value of 1, for example. At 640, a Data Size Bytes Selector can specify the amount of data typically acquired for a given query category (e.g., tiny, small, medium, large, and so forth). At 650, a Submissions Per Second input field enables specifying the number of queries of a given type are expected for a given time frame.

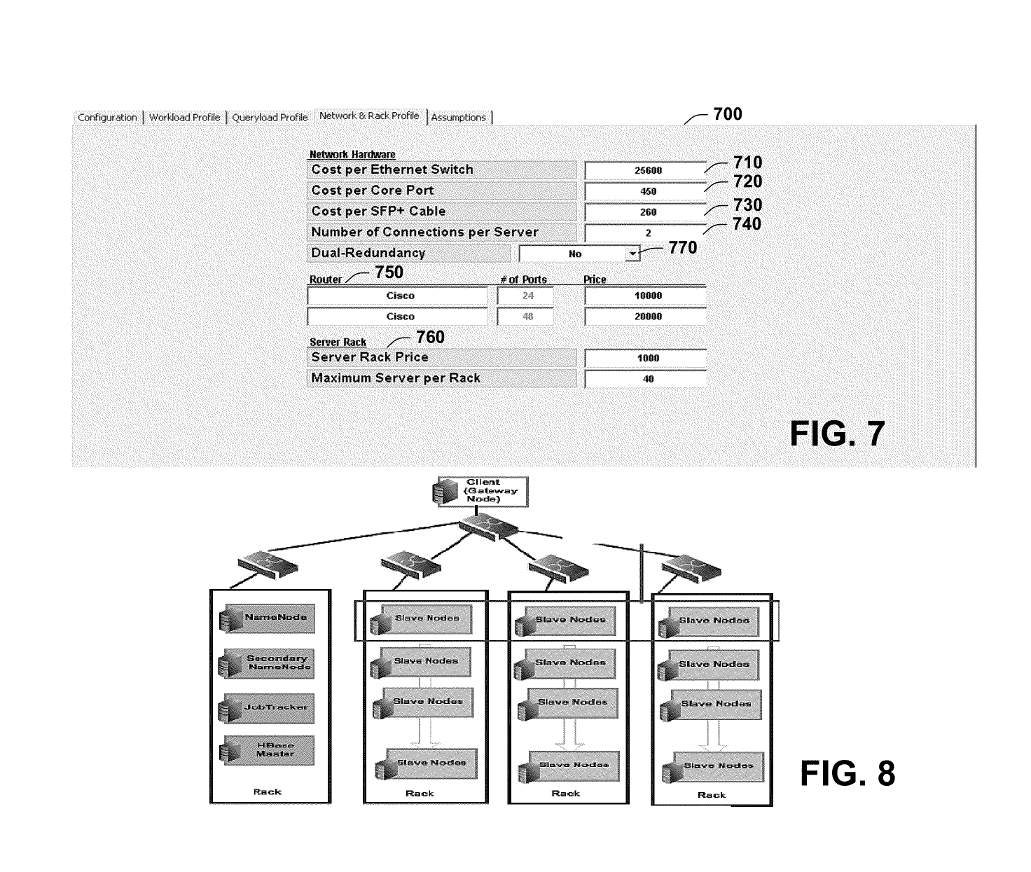

FIG. 7 illustrates an example interface 700 to specify a network and rack profile for a cloud estimator tool. Typically, medium to large clusters consists of a two or three-level architecture built with rack-mounted servers such as illustrated in the example of FIG. 8. Each rack of servers can be interconnected using a 1 Gigabit Ethernet (GbE) switch, for example. Each rack-level switch can be connected to a cluster-level switch (which is typically a larger port-density 10 GbE switch). These cluster-level switches may also interconnect with other cluster-level switches or even uplink to another level of switching infrastructure. The cost of network hardware is the sum of total Ethernet switch cost at 710, total server plus core port cost at 720, and total SFP+ cable cost at 730. Number of connections per server can be specified at 740. Router specifications can be provided at 750 along with server rack specifications at If dual-redundancy is selected at 770, then the number of inter-rack cables and the number of switches are doubled.

FIG. 9 illustrates an example interface 900 to specify an assumptions profile for a cloud estimator tool. This can include specifying power & cooling requirements 910, facilities and space requirements at 920, operational and hardware support expense at 930, and other assumptions at 940 such as system overhead and replication factor, for example. To calculate the cost of power and cooling the following factors can be included in the computation:

A. Power Consumption (watts) per server per hour;

B. Average Power Usage Effectiveness (PUE);

C. Number of Servers;

D. Server Operating Hours (number of days*24 hours); and

E. Cost per Kilowatt Hour

Some Formulas based on the above considerations A though E for computing costs for the assumptions include:

Total Power Consumption per server per hour=A*B;

Total Power Consumption (kW/number of days)=(A*C*D)/1000 W/kW; and

Total electricity cost per # of days=Total Power Consumption*E.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A non-transitory computer readable medium having machine executable instructions, the machine executable instructions comprising:
a cloud estimator tool configured to:
analyze a server configuration profile that characterizes hardware parameters for a node of a potential cloud computing environment and a load profile that characterizes computing load parameters for the potential cloud computing environment to generate a cloud computing configuration for the potential cloud computing environment; and
determine a performance estimate and a cost estimate for the cloud computing configuration based on the hardware parameters and the computing load parameters characterized in the server configuration profile and the load profile.

2. The non-transitory computer readable medium of claim 1, wherein the hardware parameters of the server configuration profile include at least one of a server type input to indicate a server model, a days of storage input to indicate an average number of days the cloud computing configuration stays in operation, and an initial disk size field specifying a disk size in bytes.

3. The non-transitory computer readable medium of claim 1, wherein the load profile includes a workload profile that specifies I/O bound workloads and CPU bound workloads for a server node and a queryload profile that specifies an amount and rate at which queries are submitted to and received from a cluster.

4. The non-transitory computer readable medium of claim 3, wherein the workload profile includes a workload type that includes at least one of data exporting, filtering, text importing, data grouping, indexing, decoding/decompressing, statistical importing, clustering/classification, machine learning, and feature extraction.

5. The non-transitory computer readable medium of claim 4, wherein the workload profile includes workload inputs to specify the workload type, the workload inputs include at least one of a workload complexity factor that defines a weight of a job type, an expansibility factor to specify a change in accumulated data due to a MapReduce operation in the potential cloud computing environment, and a submissions per second field to specify the number of data requests per second.

6. The non-transitory computer readable medium of claim 3, wherein the queryload profile includes queryload inputs to specify the queryload type, the queryload inputs include at least one of an index query, a MapReduce query, and a statistical query.

7. The non-transitory computer readable medium of claim 6, wherein the queryload inputs include at least one of a queryload complexity factor to define a weight of a query type, an analytic load factor to specify a change in accumulated data due to a query operation, and a submissions per second field to specify the number of query requests per second.

8. The non-transitory computer readable medium of claim 1, wherein the cloud estimator tool is further configured to determine hardware costs to connect a cluster of server nodes based on a network and rack profile.

9. The non-transitory computer readable medium of claim 1, wherein the cloud estimator tool is further configured to determine operating requirements for the cloud computing configuration based on an assumptions profile, wherein the assumptions profile includes at least one of power specifications for the cloud computing configuration, facilities specifications for the cloud computing configuration, and support expenses for the cloud computing configuration.

10. The non-transitory computer readable medium of claim 1, wherein the cloud estimator tool is further configured to generate an estimated results output that includes at least one of a total price estimate for the cloud computing configuration, a minimum number of nodes required estimate for the cloud computing configuration, and a performance estimate for the cloud computing configuration.

11. The non-transitory computer readable medium of claim 10, wherein the estimated results output includes the total price estimate, and the total price estimate includes at least one of a price per node, and a support price for the cloud computing configuration.

12. The non-transitory computer readable medium of claim 10, wherein the estimated results output includes the performance estimate and the performance estimate includes an estimated number of CPU nodes, an minimum number of processor cores required per the estimated number of CPU nodes, and an estimated number of data nodes required that are serviced by the estimated number of CPU nodes.

13. The non-transitory computer readable medium of claim 1, wherein the cloud estimator tool further comprises an estimator model is further configured to monitor one or more parameters of one or more cloud configurations to determine a quantitative relationship between the server configuration profile and the load profile.

14. The non-transitory computer readable medium of claim 13, wherein the estimator model is further configured to employ at least one of a predictive model and a classifier to determine the quantitative relationship between the server configuration profile and the load profile.

15. The non-transitory computer readable medium of claim 1, wherein the cloud computing configuration models a Hadoop cluster.

16. A non-transitory computer readable medium having machine executable instructions, the machine executable instructions comprising:
an estimator model configured to:
monitor a parameter of a cloud configuration; and
determine a quantitative relationship between a server configuration profile and a load profile based on the monitored parameter; and
a cloud estimator tool configured to employ the estimator model to analyze a server configuration profile that characterizes hardware parameters for a node of a potential cloud computing environment and a load profile that characterizes computing load parameters for the potential computing environment to generate a cloud computing configuration for the potential cloud computing environment, wherein the estimator model is further configured to determine a performance estimate and a cost estimate for the cloud computing configuration based on the hardware parameters of the configuration profile and the computing load parameters of the load profile.

17. The non-transitory computer readable medium of claim 16, wherein the hardware parameters of the server configuration profile include at least one of a server type input to indicate a server model, a days of storage input to indicate an average number of days the cloud computing configuration stays in operation, and an initial disk size field specifying a disk size in bytes.

18. The non-transitory computer readable medium of claim 16, wherein the load profile includes a workload profile that specifies I/O bound workloads and CPU bound workloads for a server node and a queryload profile that specifies an amount and rate at which queries are submitted to and received from a cluster.

19. The non-transitory computer readable medium of claim 18, wherein the workload profile includes a workload type that includes at least one of data exporting, filtering, text importing, data grouping, indexing, decoding/decompressing, statistical importing, clustering/classification, machine learning, and feature extraction.

20. The non-transitory computer readable medium of claim 18, wherein the queryload profile includes a queryload type that includes at least one of an index query, a MapReduce query, and a statistical query.

21. A non-transitory computer readable medium comprising:
a graphical user interface (GUI) for a cloud estimator tool, the GUI comprising:
a configuration access element to facilitate configuration of a server configuration profile that characterizes hardware parameters for a node of a potential cloud computing environment;
a workload access element to facilitate configuration of a server-bound workload for the potential cloud computing environment;
a queryload access element to facilitate configuration of a query workload for the potential cloud computing environment;
a cloud estimator actuator configured to actuate the cloud estimator tool in response to user input, wherein the cloud estimator tool is configured to:
generate a load profile that includes computing load parameters for the potential cloud computing environment based on the server-bound workload and the query workload;
generate a cloud computing configuration and a corresponding price estimate for the potential cloud computing environment based on the server configuration profile and the load profile; and
a calculated results access element configured to provide information characterizing the cloud computing configuration and the corresponding performance estimate.

22. The non-transitory computer readable medium of claim 21, wherein the server-bound workload specifies I/O bound workloads and CPU bound workloads for a server node and the query workload specifies an amount and rate at which queries are submitted to and received from a cluster.
